(19) United States
(12) Patent Application Publication
(10) Pub. No.: US 2021/0251224 A1
(43) Pub. Date: Aug. 19, 2021

(54) Alkylamine Ethoxylates as Adjuvants and Compatibilizers for Plant Biostimulants

(71) Applicant: Ethox Chemicals, LLC, Greenville, SC (US)

(72) Inventors: William C. Floyd, III, Greenville, SC (US); Charles F. Palmer, JR., Greenville, SC (US); John Moyer, IV, Greenville, SC (US); Bradley M. Swillen, Greenville, SC (US)

(73) Assignee: Ethox Chemicals, LLC

(21) Appl. No.: 17/178,306

(22) Filed: Feb. 18, 2021

Related U.S. Application Data
(60) Provisional application No. 62/977,949, filed on Feb. 18, 2020.

(51) Int. Cl. A01N 33/08; A01N 31/02; A01N 43/16; A01N 57/12; A01N 37/38; A01N 25/24; A01M 21/04; A01M 7/00; A01C 21/00; A01C 23/04

(52) U.S. Cl. CPC A01N 33/08; A01N 31/02; A01N 43/16; A01N 57/12; A01C 23/047; A01N 25/24; A01M 21/043; A01M 7/0032; A01C 21/00; A01N 37/38

(57) ABSTRACT

The present invention is related to a plant biostimulant adjuvant and a method of treating a crop with a plant biostimulant adjuvant. The plant biostimulant adjuvant comprises a plant biostimulant comprising at least one of an amino acid or a peptide derived from a plant source. The plant biostimulant adjuvant also comprises an alkyl amine alkoxylate defined by the formula:

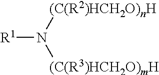

wherein:
R¹ is an alkyl of 6 to 22 carbons;
each R² and R³ are each independently H or CH₃.
n and m are each at least one and taken together n+m is 5 to 25;
and water.

### CROSS-REFERENCE TO RELATED APPLICATIONS

This application claims the priority of pending U.S. Provisional Patent Application No. 62/977,949 filed Feb. 18, 2020 which is incorporated herein by reference.

### FIELD OF THE INVENTION

The present invention is related to a combination of plant biostimulants with select alkyl amine alkoxylate and other beneficial surfactants to obtain beneficial performance in a highly concentrated formula. More specifically, the present invention is related to a preferred combination of specific plant biostimulants and alkyl amine alkoxylates which form a stable mixture for the treatment of crops, thereby increasing the effectiveness of the plant biostimulant and other adjuvants used in the mixture. This combination demonstrates pronounced physical stability and does not require such a high level of dilution, which would reduce the active components below useful levels as typically evidenced in the prior art.

### BACKGROUND

A key goal in agriculture is achieving the maximum potential and yield of each crop, preferably while using a minimum of time and resources. In many cases, these maximum yields will be sought under non-ideal conditions for the crop, such as drought, nutrient deficiency, or with exposure to herbicides that induce drag yield.

One mechanism for achieving higher plant production is the addition of plant biostimulants such as amino acid or peptide solutions that act to promote plant health and resilience. Additionally, these plant biostimulants may act to increase the efficacy of herbicides and fungicides applied to fields. However, these amino acid complexes may have a difficult time being taken into the plant, and in many cases the solutions are prone to splitting or coagulating during storage. Additionally, the vast majority of surfactants, solvents, and compatibilizers traditionally employed by those of skill in the art to improve storage stability of these plant biostimulant solutions are incompatible.

Surfactants are important materials used in agriculture. Surfactants are commonly added to concentrated formulations to improve stability and performance of pesticides. In many cases pesticide manufacturers limit the amount of surfactant in the finished product to limit cost and increase active ingredient concentration. This has increased the need for new tank additive surfactants. One drawback of adding surfactants to the spray tank is that they are known to increase the amount of fine particulates produced by the spray nozzle. This can be minimized by using nozzles with UltraCoarse (UC) spray quality but UC is not appropriate for all applications and even when a UC spray quality is appropriate it is preferred to not have the increase in fine particulates or droplets.

For the purposes of this disclosure plant biostimulants are amino acids, or a peptide comprising amino acids, that when applied to seeds, plants, or the rhizosphere, stimulate natural processes to enhance nutrient uptake, nutrient use efficiency, tolerance to abiotic stress or crop quality and yield. One class of effective plant biostimulants are plant protein hydrolysates, such as Trainer or Auxym from Hello Nature (Italpollina). These biostimulants, which comprise a complex blend of plant derived amino acids and peptides, are an important component of the inventive formula, and in this document are collectively referred to as plant peptides, peptide extracts, or protein hydrolysates. A common problem encountered when applying plant biostimulants, especially to plants and/or soil is poor wetting. Typical surfactants used to improve the wetting properties are incompatible with plant biostimulants and lead to rapid separation upon storage.

It is common for plant biostimulants to be added to application mixtures also including pesticides in-order to minimize the number of passes a grower needs to make over an agricultural field. In that case pesticide adjuvants to improve the performance or spray quality of the pesticide are typically added. One common drawback to plant biostimulant formulas is that due to their complex biological makeup, it is often highly challenging to obtain stable and uniform compositions, and favorable additives such as adjuvants and surfactants are often incompatible with the plant biostimulant formulas.

In spite of the ongoing efforts related to the application of plant biostimulants, the art still lacks a suitable system for the application of plant biostimulants which provides a stable solution and beneficial properties as evidenced by improved plant performance.

### SUMMARY OF THE INVENTION

The present invention is related to adjuvants comprising plant biostimulants combined with beneficial adjuvant surfactants, and specifically alkyl amine alkoxylates which synergistically improve the compatibility, stability, and performance of plant derived plant biostimulants.

More specifically, the present invention is related to a adjuvants comprising an alkyl amine alkoxylate, a plant derived polypeptide or amino acid, and optionally alkyl polyglycosides and glycols wherein the combination synergistically functions to improve plant health.

A particular feature of the invention is the ability to enhance the efficacy of the plant biostimulant and to provide a more uniform and predictable performance boost.

A particular advantage is the ability to provide a single concentrated formula delivering a broad spectrum of plant benefits from a number of components which are highly challenging to co-formulate, with minimal inclusion of diluents and without requiring high levels of dilution in water, such as by a factor of five or more, in order to obtain a stable mixture.

These and other advantages, as will be realized, are provided in a plant biostimulant adjuvant comprising a plant biostimulant comprising at least one of an amino acid or a peptide derived from a plant source. The plant biostimulant adjuvant also comprises an alkyl amine alkoxylate defined by the formula:

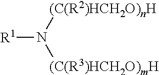

wherein:
R¹ is an alkyl of 6 to 22 carbons;
each R² and R³ are each independently H or CH₃.
n and m are each at least one and taken together n+m is 5 to 25;
and water.

Yet another embodiment is provided in a method of treating a crop. The method includes:

forming a plant biostimulant adjuvant comprising:
a plant biostimulant comprising at least one of an amino acid or a peptide derived from a plant source;
an alkyl amine alkoxylate defined by the formula:

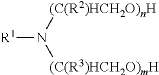

wherein:
R¹ is an alkyl of 6 to 22 carbons;
each R² and R³ are each independently H or CH₃.
n and m are each at least one and taken together n+m is 5 to 25;
mixing the plant biostimulant adjuvant with at least one auxiliary adjuvant in a tank to form a tank mixture; and
passing the tank mixture through a sprayer to form a spray on said crop.

### DESCRIPTION

The present invention is related to an adjuvant comprising a plant biostimulant, comprising amino acids or peptides comprising amino acids, an alkyl amine alkoxylate and an optional, but preferred, alkyl polyglucoside and optionally glycols which improves the physical stability, performance, wetting properties, humectancy, and formulation versatility of the plant biostimulant. The inventive adjuvant provides a consistent increase in the plant health and crop yield obtained from the plant biostimulant compared to the biostimulant alone. The formulated invention also shows improved storage stability and aqueous compatibility compared to the biostimulant alone.

The plant biostimulant is defined herein as an amino acid or a peptide comprising amino acids. The amino acid is preferably selected from the group consisting of alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine, valine, selenocysteine, pyrrolysine, and oligomers and combinations thereof. Plant based amino acids are particularly preferred. The amino acid is preferably selected from the group consisting of L-alanine, L-arginine, L-asparagine, L-cysteine, L-glutamic acid, glycine, L-histidine, L-isoleucine, L-leucine, L-lysine, L-methionine, L-phenylalanine, L-proline, L-serine, L-threonine, L-tryptophan, L-tyrosine, L-valine, and combinations and oligomers thereof. More preferably the amino acid is selected from the group consisting of L-histidine, L-isoleucine, L-leucine, L-lysine, L-methionine, L-phenylalanine, L-threonine, L-tryptophan, L-valine, and combinations thereof.

A peptide, or polypeptide, comprises 2-200 amino acids linked by peptide bonds. More preferably the peptide comprises 2-100 amino acids and more preferably 2-50 amino acids. In one embodiment the peptide comprises at least one amino acid selected from the group consisting of alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine, valine, selenocysteine and pyrrolysine. In a preferred embodiment the peptide comprises amino acids selected from the group consisting of L-alanine, L-arginine, L-asparagine, L-cysteine, L-glutamic acid, glycine, L-histidine, L-isoleucine, L-leucine, L-lysine, L-methionine, L-phenylalanine, L-proline, L-serine, L-threonine, L-tryptophan, L-tyrosine, and L-valine. Peptides comprising plant based amino acids are particularly preferred. The peptide preferably comprises amino acid selected from the group consisting of L-alanine, L-arginine, L-asparagine, L-cysteine, L-glutamic acid, L-glycine, L-histidine, L-isoleucine, L-leucine, L-lysine, L-methionine, L-phenylalanine, L-proline, L-serine, L-threonine, L-tryptophan, L-tyrosine and L-valine. More preferably the peptide comprises at least one amino acid selected from the group consisting of L-histidine, L-isoleucine, L-leucine, L-lysine, L-methionine, L-phenylalanine, L-threonine, L-tryptophan and L-valine. Particularly preferred peptides are selected from the group consisting of systemin, CLV3, ENDOD40, phytosulfokine, polaris, rapid alkalinization factor, SCR/SP11, Rotundifolia4/Devil1 and Infloresence deficient in abscission (IDA).

The alkyl amine alkoxylate used in this inventive composition is defined by the formula:

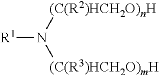

wherein:
R¹ is an alkyl of 6 to 22 carbons and more preferably 12 to 18 carbons;
each R² and R³ are each independently H or CH₃;
n and m are each at least one and taken together n+m is 5 to 25.

In one embodiment the alkyl amine alkoxylate is tallow amine ethoxylate (TAM) having 5-25 ethoxylate groups on average. More preferred is tallow amine ethoxylate having 5-15 ethoxylate groups on average. In one embodiment the alkyl amine alkoxylate is coco amine ethoxylate having 5-20 ethoxylate groups on average. More preferably the alkyl amine alkoxylate is coco amine ethoxylate having 8-15 ethoxylate groups on average.

In an embodiment alkyl polyglycoside, or more preferably alkyl polyglucoside, is advantageously added to the adjuvant. The alkyl polyglucoside is defined by:

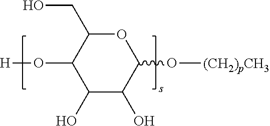

wherein:
s is 1-10 and preferably 1-5, p is 7-21 and preferably 15-17, and the alkyl chain may be branched, linear, saturated or unsaturated.

In an embodiment glycols and humectants, or more preferably glycerin and polyethylene glycol, or other glycols included but not limited to propylene glycol, hexylene glycol, sugars, polypropylene glycol, butyl carbitol, and mono ethylene, diethylene glycols and their methyl, ethyl, or butyl ethers and combinations thereof are advantageously added to the adjuvant. These additives are found to simultaneously increase the physical stability of the formula as well as improve performance due to increased humectancy.

The instant invention provides a storage stable adjuvant comprising a plant biostimulant, comprising amino acids and peptide comprising amino acids, alkyl amine alkoxylate and optionally, but preferably alkyl polyglucoside. The adjuvant provides enhanced performance of the plant biostimulant as demonstrated through plant health effects. The enhancement of performance is clearly demonstrated by the improved performance of the plant biostimulant at lower rates when combined with the selected surfactants than is needed when applied without them.

The adjuvant preferably comprises between 50 and 95 wt % alkyl amine alkoxylate and plant biostimulant combined. In a particularly preferred embodiment the adjuvant comprises 40-80 wt % biostimulant, 5-25 wt % alkyl amine alkoxylate, 5-25 wt % alkyl polyglucoside, and 5-20% glycols or humectants. More preferably, the adjuvant comprises 55-70 wt % biostimulant, 8-20 wt % alkyl amine alkoxylate, 10-20 wt % alkyl polyglucoside, and 5-15% glycols. Water may additionally be incorporated in small portions to improve formulation stability.

Surprisingly, the addition of alkyl amine alkoxylate, as defined herein, serves a dual purpose in these formulas. The alkyl amine alkoxylate improves the storage stability and compatibility of the plant biostimulant solution and increases its efficacy and yield boost on plants. Inclusion of the alkyl amine alkoxylate allows for blending and formulation with an expanded array of other surfactants and adjuvant chemistries which are, by themselves, incompatible with the plant biostimulant solution.

While most surfactants and solvents undergo physical separation from plant biostimulant solutions during storage, the present invention identifies specific alkyl amine alkoxylate as being uniquely capable of being blended with these solutions, while also enabling the incorporation of additional auxiliary adjuvants which would usually exhibit physical separation. The plant adjuvant may further comprise auxiliary adjuvants with the amount of auxiliary adjuvant in the plant adjuvant being at least 5 and no more than 60 wt %. The adjuvant is preferably used in as an additive to an aqueous tank mix with the adjuvant representing at least 0.1 to no more than 5 wt % of the aqueous tank mix, and is preferably sufficiently concentrated to only require between 0.5 and 2% of the tank mix.

Auxiliary adjuvants include materials known to enhance crop growth and health or to facilitate treatment of the crops. Particularly preferred auxiliary adjuvants include fertilizers, humectants, growth promoters, solvents, defoamers, spreaders, stickers, wetters, penetrants, drift control agents, oils, surfactants and the like. Particularly preferred auxiliary compounds include fatty alcohol ethoxylates, ethoxylated sorbitan esters, fatty acid esters, alkylamine ethoxylates, alkyl polyglycosides, ethoxylated alcohol sulfates, glycols, glycerin, and the like. Phosphorous and phosphorous based compounds have a tendency to decrease the stability of the adjuvant and therefore it is preferable that the adjuvant be void of phosphorous as evidenced by less than 0.01 wt % phosphorous in the adjuvant, more preferably less than 0.001 wt % and most preferably below detectable limits.

In another embodiment, use of adjuvant on plants exhibits an enhanced performance and yield in plants as compared to nontreated plants or plants having only been treated with a plant biostimulant lacking alkyl amine alkoxylate The adjuvant demonstrates more consistent benefit to plant health, and reduces the degree to which yield may be compromised in the presence of certain herbicides, fungicides, or other pesticides including but not limited to glufosinate, glyphosate, 2,4-dichlorophenoxy acetic acid and other phenoxy compounds, metribuzin, fomesafen, metolachlor, acetochlor, mesotrione, clethodim, tebuconazole, imazeathepyr, Imidacloprid, Acetamiprid, Clothianidin, Dinotefuran, Nithiazine, Thiacloprid, Thiamethoxam, Metalaxyl, Metalaxyl-M, Ibendazole, Benomyl, Carbendazim, Chlorfenazole, Cypendazole, Debacarb, Fuberidazole, Mecarbinzid, Rabenzazole, Thiabendazole, Thiophanate, Thiophanate-methyl, Epoxiconazole, Triadimenol, Propiconazole, Metconazole, Cyproconazole, Tebuconazole, Azaconazole, Bromuconazole, Diclobutrazol, Difenoconazole, Diniconazolke, Etaconazole, Fenbuconazole, Fluquinconazole, Flutriafol, Furconazole, Hexaconazole, Imibenconazole, Ipconazole, Myclonutanil, Penaconazole, Prothioconazole, Quinconazole, Simeconazole, Tetraconazole, Triadimefon, Triticonazole, Uniconazole, Ampropylfos, Ditalimos, Edifenphos, Fosetyl, Inezin, Iprobenfos, Izoamfos, Phosdipen, Pyrazopos, Toclofos-Ethyl, Triamiphos, Parathion, Acephate, Malathion, Methyl Parathion, Chlorpyrifos, Diazinon, Dichlorvos, Phosmet, Fenitrothion, Tetrachlorvinphos, Azamethiphos, Azinphos Methyl, Fluoxastrobin, Mandestrobin, Azoxystrobin, Coumoxystrobin, Enoxastrobin, Flufenoxystrobin, Picoxystrobin, and Pyaoxystrobin, Pyraclostrobin, Pyrametostobin, Pyrametostrobin, Dimoxystrobin, Fenaminstrobin, Metominoistrobin, Orysastrobin, Trifloxystrobin, Captafol, Captan, Ditalimfos, Folpet, Thiochlorofenphim, Carboxin, Oxycaroboxin, Amobam, Asomate, Azithiram, Carbamorph, Cufraneb, Disulfiram, Ferbam, Met am, Nabam, Tecoram, Thiram, Urbacide, Ziram and combinations thereof.

Additional additives suitable for use with the invention include additives which improve efficacy and availability of other adjuvants such as plant extracts and other biologically derived adjuvants, as well as wetters, fertilizers, humectants, or growth promoters. While not limited by theory the alkyl amine alkoxylate is proposed to owe its efficacy to a combination of wetting properties, surface tension reduction, and high solvency which aids in penetration of agricultural compounds into the leaf or root structure of plants to which it has been applied.

In a representative commercial use the adjuvant is added to a spray tank preferably containing auxiliary adjuvants. One of the problems typically encountered in the art is that the addition of surfactants to a spray tank increases the percentage of fine droplets, those less than 150 μm, which are generated during spray application of the mixture. These fine droplets have a propensity for drifting off target and can reduce the effectiveness of the components in the spray tank or lead to issues with non-target plants and/or animals. This off-target movement is referred to as spray drift. It is a preferred advantage of the inventive formula that its addition to a tank mix will result in no more fines than would be generated in the absence of the formula, and even more preferred that fine generation is lower than a comparable tank mix lacking the inventive formula.

Auxiliary adjuvants include additives such as pesticides, herbicides, fungicides, fertilizers, humectants, growth promoters solvents, humectants, defoamers, oils, or surfactants and the like. Particularly preferred auxiliary adjuvants include polyethylene glycol, and propylene glycol and the like. Phosphorous and phosphorous based compounds have a tendency to decrease the stability of the adjuvant and therefore it is preferable that the adjuvant be void of phosphorous as evidenced by less than 0.01 wt % phosphorous in the adjuvant, more preferably less than 0.001 wt % and most preferably below detectable limits.

A particular advantage of the invention is that the adjuvant, or an aqueous tank comprising the adjuvant, has an equal or lower amount of fine particles less than 150 μm compared to the application mixture containing just the auxiliary adjuvant and particularly pesticide. In the preferred embodiment, a spray tank mixture containing the inventive biostimulant formula will show a reduction in fines of at least 5% as compared to a tank mix lacking the biostimulant formula, and more preferably the amount of fines below 150 μm will be reduced by at least 10% than a tank mix lacking the biostimulant formula. For the purposes of this invention the reduction in fine droplets is defined by a comparative test wherein the inventive composition is compared to an identical spray lacking the plant biostimulant adjuvant wherein the compositions are sprayed under the same conditions. The term “identical spray lacking the plant biostimulant adjuvant” comprises the same composition of every component except the alkyl amine alkoxylate which is absent and replace by water.

Additionally, in the preferred embodiment the average size of the droplets within the spray, typically referred to as the DV50 by those familiar in the art, will be the same or less than a tank mix lacking the inventive formula. This aspect of not increasing the average droplet size of the spray is advantageous due to the increased coverage and deposition obtained from smaller droplets. Alternative drift control agents which reduce fines by increasing average droplet sizes, such a polyacrylamides or thickening polymers, suffer from decreased herbicide coverage because they reduce the number of fine particles by generally increasing the spray particle size which also increases the average particle size and the number of large spray particles.

The present invention enables the mixture of plant biostimulants and auxiliary adjuvants specific to plant health; particularly herbicides, pesticides, fungicides and the like; without the need to add an auxiliary adjuvants specific to application advantages; such as drift control agents, surfactants, and the like; as the inventive biostimulant improves the wetting properties of the plant biostimulant also improves the performance of certain pesticides. Furthermore, more complex compositions containing additional components such as water conditioners and/or drift reducing agents are possible within this invention whereas these components are typically not compatible with formulations utilizing amino acids or peptides. The invention significantly improves the agricultural utility of the plant biostimulant, further reducing the need for additional adjuvants and even in this more complex mixture, formulations have been identified as stable.

It has been known in the art that plant protein hydrolysate formulas, which comprise amino acids and peptides comprising amino acids, tend to have certain undesirable qualities, such as poor wetting ability, a tendency to haze or produce precipitant, and a physical incompatibility with many desirable components such as surfactants, herbicides, or even water. For example, plant biostimulants alone will haze under accelerated storage stability, and will also produce a hazy and turbid solution when mixed with an equal volume of water. Typical amines such as ammonia and triethanolamine very slightly improved the protein hydrolysate's compatibility with water, however, the solutions are still cloudy indicating a lack of compatibility.

It was surprisingly found that ethoxylated coco, and especially tallow, alkyl amines provide a consistent and significant improvement in solution clarity and stability. This is contrary to expectations in the art since the long alkyl chains would be expected to be contrary to compatibility with water. Additionally, it has been found that while alkyl polyglucosides are not strictly required for a stable formula, their inclusion improves wetting properties and overall adjuvancy performance. Despite significant efforts to include alternate surfactant and adjuvant chemistries, it was found that these resulted in unstable formulas unless diluted below a useful and practical concentration.

This invention of stable compositions with multiple functionalities overcomes a common challenge of incompatibility and enables a user to achieve desired results while using fewer products and at lower total use rate.

Another advantage of the instant invention is temperature stability. Typical problems that are encountered while attempting to form mixtures of amino acids and peptides are splitting, hazing or precipitation during storage at room temperature and storage under higher temperatures or cooler temperatures does not mitigate the problem. The adjuvants are stable from −20° C.-54° C. which is a significant advance in the art.

The present invention is particularly suitable for use with plant-based peptides and particularly plant hydrolysates. Though suitable for use with animal or seaweed extracts, the same results are not as advantageous. Multiple exhaustive formulation experiments have determined that the combination used in the inventive formula is uniquely suited for improving the stability and performance properties of plant based protein hydrolysates. Without being limited to theory, the advantages with plant-based peptides are suspected to be due to the specific peptide sequences present in the lysate and the specific manufacturing process used in its production.

### EXAMPLES

Without being tied to a specific mixing procedure, generally all ingredients were added to a mixing container at the desired concentration and the mixture was shaken or stirred under ambient temperature until combined. Order of addition effects were not observed. Once combined the mixtures were observed for stability at room temperature, in 54° C. oven and −20° C. freezer.

### Example Formulas

The following examples demonstrate the importance of an alkyl polyglucoside in the present invention. In an 8 dram vial at room temperature the following formulas were blended with mild agitation. The samples were then stored at 54° C. for at least 24 hours and up to two weeks in order to ascertain physical stability. Example 1 is inventive, with Examples 2-17 and 19-25 being comparative examples demonstrating the narrow formulation window allowing a stable formula as prescribed by the invention.

### Example 1

12 g plant peptide
2.9 g TAM-15 Tallow alkyl amine ethoxylated with 15 moles of ethylene oxide
1.2 g glycerin
0.5 g water
0.5 g sodium diisooctyl sulfosuccinate, 70% in propylene glycol (Isodoss 70PG)

### 0.7 g PEG 200; and

2.2 g Glucopon 425N alkylpolyglucoside.

### Example 2

12 g plant peptide
2.9 g TAM-15 Tallow alkyl amine ethoxylated with 15 moles of ethylene oxide
1.2 g glycerin
0.5 g water
0.5 g sodium diisooctyl sulfosuccinate, 70% in propylene glycol

### 0.7 g PEG 200; and

2.2 g decyl alcohol ethoxylated with four moles of ethylene oxide.

### Example 3

12 g plant peptide
2.9 g TAM-15 Tallow alkyl amine ethoxylated with 15 moles of ethylene oxide
1.2 g glycerin
0.5 g water
0.5 g sodium diisooctyl sulfosuccinate, 70% in propylene glycol

### 0.7 g PEG 200; and

2.2 g decyl alcohol ethoxylated with six moles of ethylene oxide.

### Example 4

12 g plant peptide
2.9 g TAM-15 Tallow alkyl amine ethoxylated with 15 moles of ethylene oxide
1.2 g glycerin
0.5 g water
0.5 g sodium diisooctyl sulfosuccinate, 70% in propylene glycol

### 0.7 g PEG 200; and

2.2 g decyl alcohol ethoxylated with nine moles of ethylene oxide.

### Example 5

12 g plant peptide
2.9 g TAM-15 Tallow alkyl amine ethoxylated with 15 moles of ethylene oxide
1.2 g glycerin
0.5 g water
0.5 g sodium diisooctyl sulfosuccinate, 70% in propylene glycol

### 0.7 g PEG 200; and

2.2 g Lauryl alcohol ethoxylated with 4 moles of ethylene oxide.

### Example 6

12 g plant peptide
2.9 g TAM-15 Tallow alkyl amine ethoxylated with 15 moles of ethylene oxide
1.2 g glycerin
0.5 g water
0.5 g sodium diisooctyl sulfosuccinate, 70% in propylene glycol

### 0.7 g PEG 200; and

2.2 g Lauryl alcohol ethoxylated with 7 moles of ethylene oxide.

### Example 7

12 g plant peptide
2.9 g TAM-15 Tallow alkyl amine ethoxylated with 15 moles of ethylene oxide
1.2 g glycerin
0.5 g water
0.5 g sodium diisooctyl sulfosuccinate, 70% in propylene glycol

### 0.7 g PEG 200; and

2.2 g Lauryl alcohol ethoxylated with 9 moles of ethylene oxide.

### Example 8

12 g plant peptide
2.9 g TAM-15 Tallow alkyl amine ethoxylated with 15 moles of ethylene oxide
1.2 g glycerin
0.5 g water
0.5 g sodium diisooctyl sulfosuccinate, 70% in propylene glycol

### 0.7 g PEG 200; and

2.2 g coco alkyl amine ethoxylated with 2 moles of ethylene oxide.

### Example 9

12 g plant peptide
2.9 g TAM-15 Tallow alkyl amine ethoxylated with 15 moles of ethylene oxide
1.2 g glycerin
0.5 g water
0.5 g sodium diisooctyl sulfosuccinate, 70% in propylene glycol

### 0.7 g PEG 200; and

2.2 g tallow alkyl amine ethoxylated with 20 moles of ethylene oxide, diethyl sulfate quat.

### Example 10

12 g plant peptide
2.9 g TAM-15 Tallow alkyl amine ethoxylated with 15 moles of ethylene oxide
1.2 g glycerin
0.5 g water
0.5 g sodium diisooctyl sulfosuccinate, 70% in propylene glycol

### 0.7 g PEG 200; and

2.2 g Pluronic L-64 ethylene oxide/propylene oxide copolymer.

### Example 11

12 g plant peptide
2.9 g TAM-15 Tallow alkyl amine ethoxylated with 15 moles of ethylene oxide
1.2 g glycerin
0.5 g water
0.5 g sodium diisooctyl sulfosuccinate, 70% in propylene glycol

### 0.7 g PEG 200; and

2.2 g Pluronic P-104 ethylene oxide/propylene oxide copolymer.

### Example 12

12 g plant peptide
2.9 g TAM-15 Tallow alkyl amine ethoxylated with 15 moles of ethylene oxide
1.2 g glycerin
0.5 g water
0.5 g sodium diisooctyl sulfosuccinate, 70% in propylene glycol

### 0.7 g PEG 200; and

2.2 g oleic acid ethoxylated with seven moles of ethylene oxide.

### Example 13

12 g plant peptide
2.9 g TAM-15 Tallow alkyl amine ethoxylated with 15 moles of ethylene oxide
1.2 g glycerin
0.5 g water
0.5 g sodium diisooctyl sulfosuccinate, 70% in propylene glycol

### 0.7 g PEG 200; and

2.2 g oleic acid ethoxylated with 14 moles of ethylene oxide.

### Example 14

12 g plant peptide
2.9 g TAM-15 Tallow alkyl amine ethoxylated with 15 moles of ethylene oxide
1.2 g glycerin
0.5 g water
0.5 g sodium diisooctyl sulfosuccinate, 70% in propylene glycol

### 0.7 g PEG 200; and

2.2 g castor ethoxylated with five moles of ethylene oxide.

### Example 15

12 g plant peptide
2.9 g TAM-15 Tallow alkyl amine ethoxylated with 15 moles of ethylene oxide
1.2 g glycerin
0.5 g water
0.5 g sodium diisooctyl sulfosuccinate, 70% in propylene glycol

### 0.7 g PEG 200; and

2.2 g castor ethoxylated with 30 moles of ethylene oxide.

### Example 16

12 g plant peptide
2.9 g TAM-15 Tallow alkyl amine ethoxylated with 15 moles of ethylene oxide
1.2 g glycerin
0.5 g water
0.5 g sodium diisooctyl sulfosuccinate, 70% in propylene glycol

### 0.7 g PEG 200; and

2.2 g 2-ethylhexanol ethoxylated with two moles of ethylene oxide.

### Example 17

12 g plant peptide
2.9 g TAM-15 Tallow alkyl amine ethoxylated with 15 moles of ethylene oxide
1.2 g glycerin
0.5 g water
0.5 g sodium diisooctyl sulfosuccinate, 70% in propylene glycol

### 0.7 g PEG 200; and

2.2 g 2-ethylhexanol ethoxylated with five moles of ethylene oxide.

### Example 18

12 g plant peptide
2.9 g TAM-15 Tallow alkyl amine ethoxylated with 15 moles of ethylene oxide
1.2 g glycerin
2.7 g water as diluent control
0.5 g sodium diisooctyl sulfosuccinate, 70% in propylene glycol; and

### 0.7 g PEG 200.

### Example 19

12 g plant peptide
3.6 g decyl alcohol ethoxylated with 4 moles of ethylene oxide
1.2 g glycerin
0.5 g water
0.5 g sodium diisooctyl sulfosuccinate, 70% in propylene glycol; and
2.2 g Glucopon 425N alkylpolyglucoside.

### Example 20

12 g plant peptide
3.6 g decyl alcohol ethoxylated with 6 moles of ethylene oxide
1.2 g glycerin
0.5 g water
0.5 g sodium diisooctyl sulfosuccinate, 70% in propylene glycol; and
2.2 g Glucopon 425N alkylpolyglucoside.

### Example 21

12 g plant peptide
3.6 g lauryl alcohol ethoxylated with 4 moles of ethylene oxide
1.2 g glycerin
0.5 g water
0.5 g sodium diisooctyl sulfosuccinate, 70% in propylene glycol; and
2.2 g Glucopon 425N alkylpolyglucoside.

### Example 22

12 g plant peptide
3.6 g lauryl alcohol ethoxylated with 7 moles of ethylene oxide
1.2 g glycerin
0.5 g water
0.5 g sodium diisooctyl sulfosuccinate, 70% in propylene glycol; and
2.2 g Glucopon 425N alkylpolyglucoside.

### Example 23

12 g plant peptide
3.6 g Pluronic L-62 polyethylene oxide/polypropylene oxide copolymer
1.2 g glycerin
0.5 g water
0.5 g sodium diisooctyl sulfosuccinate, 70% in propylene glycol; and
2.2 g Glucopon 425N alkylpolyglucoside.

### Example 24

12 g plant peptide
3.6 g Pluronic P-104 polyethylene oxide/polypropylene oxide copolymer
1.2 g glycerin
0.5 g water
0.5 g sodium diisooctyl sulfosuccinate, 70% in propylene glycol; and
2.2 g Glucopon 425N alkylpolyglucoside.

### Example 25

12 g plant peptide
3.6 g oleic acid ethoxylated with 7 moles of ethylene oxide
1.2 g glycerin
0.5 g water
0.5 g sodium diisooctyl sulfosuccinate, 70% in propylene glycol; and
2.2 g Glucopon 425N alkylpolyglucoside.

At the conclusion of the observation period only Example 1, which embodies the present invention, and sample 18, which requires dilution by an inert substance (water), were found to be uniform clear liquids. The other samples were each split into two layers, with the exception of sample 13, which split into three layers.

### Drift Control Examples

### Drift Control Example 1

A study was conducted in a spray chamber equipped with a Helos KR laser from Sympatec capable of determining the particle size distribution of an application as it leaves a nozzle. This test was conducted at a pressure of 63 psi using a TTI11004 nozzle. Each mixture was added to a spray canister which was then pressurized. A pressure gauge on the tank confirmed the pressure was 63 psi. The pressured mixtures were then sprayed from a stationary position so that the Helos laser could measure the particle size of the droplets as they fell from the nozzle. The laser is approximately 18-24″ below the spray nozzle.

Two mixtures were prepared. Each mixture comprised commercially available Xtendimax herbicide which is commercially available dicamba-based herbicide available from Bayer Cropscience. In Mixture 1 Xtendimax herbicide was at 1.1%, which corresponds to a typical use rate. Mixture 2 contained 1.1% Xtendimax herbicide and 0.5% v/v of an inventive adjuvant comprising an aqueous plant peptide solution, a tallow alkyl amine ethoxylate, an alkylpolyglycoside, and glycols.

Mixture 2 had a much lower amount of fine particles of less than 120 μm than a Mixture 1. This is surprising since Mixture 2 contains surfactant materials which would be expected to reduce the surface tension and Mixture 1 does not. Typically, the addition of surfactant increases the % fine particles of a spray mixture. The surface tension of Mixture 1 was measured as 71.4 dynes/cm whereas the surface tension of Mixture 2 was 45.7 dynes/cm. Fewer fine particles with lower surface tension is contrary to the expectations in the art.

### Drift Control Example 2

Generally materials that increase the viscosity of the spray solution (such as guar and polyacrylamide polymers) are known to increase the average size of spray particles and materials that reduce the surfactant tension, such as surfactants, are known to decrease the average size of spray particles. As a result, solutions containing surfactants typically have a higher percentage of driftable fines than corresponding solutions lacking surfactants. For these reasons, it was expected that the inventive composition would either not affect or increase the percentage of fines particles. We found that the inventive formula surprisingly decreased the percentage of fine particles compared to a treatment of Xtendimax alone. This is an unexpected benefit of the inventive composition.

The following spray samples were prepared to a total weight of 3000 g each.

### Sample 1: Water

### Sample 2: 34.5 g Xtendimax and 2965.5 g Water;

Sample 3: 34.5 g Xtendimax, 15 g plant peptide and 2950.5 g of Water;
Sample 4: 34.5 g Xtendimax, 15 g of a mixture of the surfactants used in the inventive composition, but lacking the plant peptide portion and 2950.5 g of Water; and
Sample 5: 34.5 g Xtendimax, 15 g of the inventive composition and 2950.5 g Water.

Xtendimax refers to the herbicide Xtendimax with Vaporgrip Technology manufactured by Bayer Corporation. The plant peptide protein hydrolysate used in this example was Trainer, manufactured by Hello Nature (Italpollina). The inventive compositon used in Sample 5 is a blend of the plant peptide and the surfactant blend, which is manufactured by Ethox Chemicals, LLC. Once prepared the samples were placed in spray canisters and pressurized to 63 psi. The pressurized samples were sprayed out of a TTI11004 nozzle. Each sample was sprayed for 10 seconds and the particle size was measured on a HELOS laser system manufactured and installed by Sympatech. Each particle size measurement was repeated 5 times, except the water baseline which was repeated 3 times. The percent fines are reported as the percentage of droplets having a diameter of less than 150 um, and the DV50 is the average size of the droplets in the spray. The spray samples were also tested for dynamic surface tension on a Sensadyne bubble tensiometer manufactured by Sensadyne Instrument Division. The spray samples were then tested for viscosity on a BYK DVE viscometer at room temperature using a 61 spindle at 30 rpm speed. In all cases no additional processing was performed on the samples beyond diluting in water and briefly shaking until mixed. The results are presented in Table 1.

TABLE 1

| | % fines | | DV 50 | | Surface | Viscosity |
|---|---|---|---|---|---|---|
| Sample | (micron) | std dev | (micron) | std dev | tension | (cP) |
| Sample 1 | 4.1 | 0.4356 | 577.29 | 30.458 | 72 mN/m | — |
| Sample 2 | 4.0 | 0.1488 | 555.318 | 7.812 | 71.0 mN/m | 2.10 |
| Sample 3 | 3.6 | 0.3232 | 569.122 | 9.080 | 68.3 mN/m | 2.20 |
| Sample 4 | 4.0 | 0.5574 | 513.144 | 15.017 | 43.4 mN/m | 2.00 |
| Sample 5 | 3.4 | 0.2058 | 538.402 | 13.978 | 46.7 mN/m | 1.80 |

As shown in Table 1, Xtendimax, which contains surfactants, slightly increases the % fines and lowers the average particle diameter (DV50) compared to water. Surprisingly, sample 3 demonstrates that the plant peptide hydrolysate slightly lowers % fines. Sample 4 demonstrates that while surfactants typically increase fines, the specific blend used in the inventive composition do not appreciably cause the % fines to increase, which is unexpected. Finally sample 5 shows that the specific combination of the plant peptides and the surfactants used in the inventive composition even further decrease fines generation. The results presented in Table 1 demonstrate that despite the surface tension reduction seen with Xtendimax and the inventive composition, the inventive composition resulted in both fewer fine particles less than 150 micron and a smaller DV 50, or average particle size diameter. This reduction in % fines is unexpected in part because the average particle size is decreasing with the addition of the inventive composition and because the viscosity of the sample is not higher than the sample of Xtendimax. The viscosity of Sample 5, which contains the commercial embodiment of the inventive composition, is less than the viscosity of Sample 2. Including the inventive compositon in tank mixtures with pesticides, for example Xtendimax, improves on-target application of pesticides resulting in fewer fine particles, without increasing viscosity or overall average droplet diameter and still providing a surfactant effect.

The following comparative examples demonstrate necessity of the central invention's specific composition in order to obtain a high concentrated and stable formulation.

### Comparative 1

A mixture comprising 60.00 wt % plant peptide hydrolysate and 40.00 wt % alkyl polyglucoside with 8-16 carbons.

### Inventive 1

A mixture comprising 60.00 wt % plant peptide hydrolysate; 30.00 wt % ethoxylated cocoamine reacted with 15 moles of ethylene oxide on average; 10% PEG 200.

### Comparative 2

A mixture comprising 60.00 wt % plant peptide hydrolysate; 18.00 wt % CAM 20; 11.00 wt % alkyl polyglucoside with 8-16 carbons; 6.00 wt % glycerine; 2.50 wt % Isodoss 70 PG; 2.50 wt % water.

### Inventive 2

A mixture comprising 60.00 wt % plant peptide hydrolysate; 18.00 wt % TAM 20; 11.00 wt % alkyl polyglucoside with 8-16 carbons; 6.00 wt % glycerine; 2.50 wt % Isodoss 70 PG; 2.50 wt % water.

### Comparative 3

A mixture comprising 60.00 wt % Bioberica AA-18, an animal based peptide; 18.00 wt % TAM 20; 11.00 wt % alkyl polyglucoside with 8-16 carbons; 6.00 wt % glycerine; 2.50 wt % Isodoss 70 PG; 2.50 wt % water.

Inventive 1 and Inventive 2 were stable indicating that the mixture resulted in a single phase formulation without precipitation and free of particulates.
Comparative 1 was stable however the properties were not desirable.
Comparative 2 was not stable Comparative 3 was not stable.

### Comparative 4

A mixture was prepared comprising 19 g of plant peptide hydrolysate and 3 g of water. At room temperature the mixture was cloudy with solids settling in the container. At 55° C. the mixture was clear with floating solid. The mixture was determined to be unstable, indicating that dilution alone is insufficient to stabilize the biostimulant.

### Comparative 5

A mixture was prepared comprising 19 g of plant peptide hydrolysate and 3 g of ammonium hydroxide. At room temperature to mixture was cloudy and at 55° C. the mixture separated into two phases. The mixture was determined to be unstable.

### Comparative 6

A mixture was prepared comprising 19 g of plant peptide hydrolysate and 3 g of monoethanolamine. The mixture was cloudy at room temperature and at 55° C. The mixture was determined to be unstable.

### Comparative 7

A mixture was prepared comprising 19 g of plant peptide hydrolysate and 3 g of triethanolamine. The mixture was cloudy at room temperature and at 55° C. but less so than the mixture with ammonium hydroxide or monethylamine. The mixture was determined to be unstable.

### Comparative 8

A mixture was prepared comprising 19 g of plant peptide hydrolysate and 3 g of cocoamine ethoxylated with 5 ethylene oxide groups on average. At room temperature the mixture was hazy and at 55° C. the mixture had a layer of solids on the bottom of the container. The mixture was determined to be unstable.

### Comparative 9

A mixture was prepared comprising 19 g of plant peptide hydrolysate and 3 g of cocoamine 10 EO wherein the cocoamine was ethoxylated with 10 ethylene oxide groups on average. At room temperature the mixture was hazy and at 55° C. the mixture had a layer of solids on the bottom of the container. The mixture was determined to be unstable.

### Comparative 10

A mixture was prepared comprising 19 g of plant peptide hydrolysate and 3 g of cocoamine ethoxylated with 15 ethylene oxide groups on average. At room temperature the mixture was cloudy and at 55° C. the mixture had solids dispersed throughout. The mixture was determined to be unstable.

### Comparative 11

A mixture was prepared comprising 19 g of plant peptide hydrolysate and 3 g of tallowamine ethoxylated with 2 ethylene oxide groups on average. At room temperature solids were visible and at 55° C. the mixture had two phases. The mixture was determined to be unstable.

### Comparative 12

A mixture was prepared comprising 19 g of plant peptide hydrolysate and 3 g of tallowamine ethoxylated with 10 ethylene oxide groups on average. At room temperature to mixture was hazy and at 55° C. the layers of solid were visible in the container. The mixture was determined to be unstable.

### Comparative 13

A mixture was prepared comprising 19 g of plant peptide hydrolysate and 3 g of tallowamine ethoxylated with 15 ethylene oxide groups on average. At room temperature the mixture was hazy and at 55° C. the mixture was clear with a slight film on the bottom of the container. The mixture was determined to be unstable.

### Comparative 14

A mixture was prepared comprising 19 g of plant peptide hydrolysate and 3 g of alkyl polyglucoside. At room temperature to mixture was hazy and at

55° C. a gel was visible in the bottom of the container. The mixture was determined to be unstable.

### Inventive 3

The inventive Formula at room temperature and at 55° C. the mixture was clear.

### Inventive 4

A mixture was prepared comprising 19 g of plant peptide hydrolysate,

0.39 g of alkyl polyglucoside and 0.61 g of tallowamine 15 EO wherein the tallowamine was ethoxylated with 15 ethylene oxide groups on average. At room temperature and at 55° C. the mixture was clear.

### Inventive 5

A mixture was prepared comprising 19 g of plant peptide hydrolysate, 3 g of a mixture of 80 tallowamine ethoxylated with 15 moles of ethylene oxide on average with 10% each polyethylene glycol with an average molecular weight of 200 and 400. At room temperature the mixture was hazy and at 55° C. the mixture was clear with a slight film on the bottom.

### Plant Health TrialsCorn

Plant biostimulants such as Trainer, which was used in these studies, and other peptide hydrolysates have been demonstrated to have plant health effects on row crops. In this study we investigated the effects from the addition of this plant biostimulant alone and as a component in a surfactant adjuvant herein referred to as the inventive formula, which is the central invention of this work. In both cases the treatment rate of plant biostimulant was less than what is typically considered effective so that we could evaluate the adjuvant effect of the inventive formula. The study summarized below was conducted in Tennessee. Liberty® Herbicide (Liberty) produced by BASF was purchased and used as a commercially available glufosinate based herbicide. Corn plants were treated with Liberty, Liberty plus plant peptide hydrolysate, and Liberty plus the inventive composition comprising a formula containing plant peptides, an alkyl amine ethoxylate, an alkylpolyglucoside, and glycols. In all treatments the Liberty rate was held constant at 29 oz/A and both adjuvants were tested 12.8 oz per acre. As stated previously the recommended use rate of the plant peptide extract is 16 oz/A. The spray volume for the treatment was 20 gals per A. Since The inventive formula is further formulated with surfactants and other ingredients the actual rate of plant biostimulant delivered is lower than with plant peptide alone. However, the data surprisingly demonstrates that the lower rate was equally or more beneficial to the corn plants. The data in Table 2 is the average value from the tests.

TABLE 2

| | The Inventive Formula and Corn Plant Health | |
|---|---|---|
| | | Grain Test |
| | Yield | Weight |
| | (Bu/A) | (lbs/Bu) |
| Liberty | 177.9 | 57.3 |
| Liberty + plant peptide | 175.4 | 57.65 |
| Liberty + the inventive | 179.3 | 57.95 |
| formula | | |

The data presented in Table 2 indicates an increase in yield and grain test weight with the application of Liberty+the inventive formula compared to either Liberty or Liberty plus the plant biostimulant with surfactant. Yield is an important criteria for farmers since it is the main determining factor for income per A. Grain test weight is important in corn as an indicator of yield quality. It is particularly interesting in this study since grain test weight in corn is typically impacted by stress encountered during ear fill. This data demonstrates that the inventive formula resulted in the highest grain test weight despite delivering the lowest rate of plant biostimulant suggesting that the surfactant component of the inventive formula improves its efficiency.

### Cotton

Plant biostimulants such as Trainer have been demonstrated to have plant health effects on row crops at the recommended use rate of is 16 oz/A. In this study we investigated the effects from the addition of this plant biostimulant alone and as a component in a surfactant adjuvant herein called the inventive formula. In both cases the rate of plant biostimulant was less than what is typically considered effective so that we could evaluate the adjuvant effect of the inventive formula. All of these treatments contained glyphosate herbicide, rerfered to as Roundup. The herbicide was purchased and refers to Roundup Powermax® manufactured by Bayer Crop Science. The use rates for the plant peptide and the inventive formula in this trial were 6.4 oz/A. The rate of plant biostimulant delivered in the the inventive formula application was less than that delivered in the application of peptide alone since the inventive formula is formulated with surfactants and other ingredients. The treatments tested were Mepiquat+Roundup, Mepiquat+Roundup+plant peptideand Mepiquat+Roundup+the inventive formula. Each treatment was applied three times over the course of the season with the mepiquat rate being 8, 16, 16 oz/A in each application respectively. The Roundup rate was held constant in all applications at 22 oz/A. Plant health effects measured were stalk diameter and lint yield. The data below illustrate the positive effects on both features with the addition of peptide alone and the inventive formula. Surprisingly, even with the lower use rate of plant biostimulant in the inventive formula compared to peptide alone, similar effects on plant health were observed. The study results demonstrated a lint yield increased from an average of 741.02 Lbs without addition of the plant biostimulant to 828.24 lbs and 755.41 lbs with inclusion of plant peptide and the inventive formula, respectively. Stalk diameter, which is understood as a leading indicator of overall cotton plant health also increased from 8.5 mm without plant biostimulant to 10.7 and 10.1 mm with peptide alone and the inventive formula respectively. These data presented in Table 3 demonstrates that combining peptide with the adjuvant package used in the inventive formula provides the same plant health benefit of the plant biostimulant but at a lower use rate once again demonstrating a higher efficiency with the inventive formula treatment.

TABLE 3

| Treat- | | Plant | | Height | Lint | Stalk |
|---|---|---|---|---|---|---|
| ment | | Height | Total | to Node | Yield | Diameter |
| # | Details | (in) | Nodes | Ratio | (LBs) | (mm) |
| 2 | Mepiquat + | 19.2 | 18.3 | 1.05 | 741.015 | 8.5 |
| | Glyphosate | | | | | |
| 3 | Mepiquat + | 22 | 18.1 | 1.22 | 828.24 | 10.7 |
| | Glyphosate + | | | | | |
| | 12.8 oz/A | | | | | |
| | peptide | | | | | |
| 4 | Mepiquat + | 20.3 | 19 | 1.07 | 755.41 | 10.1 |
| | Glyphosate + | | | | | |
| | 6.4 oz/A the | | | | | |
| | inventive | | | | | |
| | formula | | | | | |

### Weed Control Data

Weeds are unwanted plants which germinate from seeds in crop fields. The plants utilize valuable resources in the field thus robbing the desired crop of its yield potential. For this reason herbicides are critically important in modern farming for the control of weeds. It is beneficial to use the lowest effective rate of herbicide possible to minimize the cost and minimize any risk of impact to the environment from the usage of herbicides. In these trials we have tested the effect of adjuvants on the weed control of two herbicides on a very common, troublesome weed known as Palmer Amaranth. The two herbicides tested were 2,4-D (2,4-D Amine 4) and dicamba (Xtendimax® with Vaporgrip® Technology). Dicamba is refered to below as DGA dicamba. In each case we tested the herbicide without an adjuvant, with a commonly used premium, high concentrate, 95% active, low foaming, nonionic surfactant adjuvant, and with the inventive formula. The weeds were rated for % control at 14 days after treatment. The rate of herbicide and adjuvant, when included, is captured in Table 4.

TABLE 4

| | Avg Rating 14 |
|---|---|
| Test mixture | DAT |
| DGA dicamba (0.36 lbs ae/A) | 80.0 |
| DGA dicamba + 0.5% v/v Premium | 85.0 |
| Adjuvant | |
| DGA dicamba + 0.5% v/v the inventive | 88.8 |
| formula | |
| 2,4-D Amine 4 (0.25 lbs ae/A) | 33.8 |
| 2,4-D Amine 4 + 0.5% v/v Premium | 78.8 |
| Adjuvant | |
| 2,4-D Amine 4 + 0.5% v/v the inventive | 77.5 |
| formula | |

The data provided in Table 4 demonstrates two important points. First it demonstrates the value of an adjuvant with both 2,4-D and Dicamba. Second it demonstrates that mixtures containing the inventive formula perform equal or better than mixtures containing the premium adjuvant for control of palmer amaranth.

It has been surprisingly discovered that even though the inventive formula has properties that clearly demonstrate its performance as a surfactant such as reduced surface tension, the inventive formula does not increase the percentage of fine spray droplets. The invention provides for a pesticide or fertilizer application with a surfactant containing adjuvant which does not increase the % fines of the application mixture and as such has less of a tendency to drift compared to other mixes.

The invention has been described with reference to the preferred embodiments without limit thereto. One of skill in the art would realize additional embodiments and improvements which are within the scope of the claimed invention as set forth in the claims appended hereto.

1. A plant biostimulant adjuvant comprising:
a plant biostimulant comprising at least one of an amino acid or a peptide derived from a plant source;
an alkyl amine alkoxylate defined by the formula: 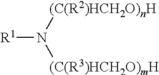
wherein:
R¹ is an alkyl of 6 to 22 carbons;
each R² and R³ are each independently H or CH₃.
n and m are each at least one and taken together n+m is 5 to 25;
and water.

2. The plant biostimulant adjuvant of claim 1 wherein R¹ is an alkyl of 12 to 18 carbons.

3. The plant biostimulant adjuvant of claim 1 wherein said peptide comprises 2-200 amino acids.

4. The plant biostimulant adjuvant of claim 1 wherein said amino acid is selected from the group consisting of alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine, valine, selenocysteine, pyrrolysine, and oligomers and combinations thereof.

5. The plant biostimulant adjuvant of claim 4 wherein said amino acid is selected from the group consisting of L-alanine, L-arginine, L-asparagine, L-cysteine, L-glutamic acid, glycine, L-histidine, L-isoleucine, L-leucine, L-lysine, L-methionine, L-phenylalanine, L-proline, L-serine, L-threonine, L-tryptophan, L-tyrosine, L-valine, and combinations thereof.

6. The plant biostimulant adjuvant of claim 5 wherein said amino acid is selected from the group consisting of L-histidine, L-isoleucine, L-leucine, L-lysine, L-methionine, L-phenylalanine, L-threonine, L-tryptophan, L-valine, and combinations thereof.

7. The plant biostimulant adjuvant of claim 1 comprising at least 50 to no more than 95 wt % said plant biostimulant and said alkyl amine alkoxylate combined.

8. The plant biostimulant adjuvant of claim 1 further comprising an alkyl polyglucoside defined by the formula: 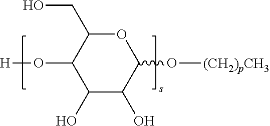
wherein:
s is 1-5; and
p is 7-21.

9. The plant biostimulant adjuvant of claim 8 wherein p is 15-17.

10. The plant biostimulant adjuvant of claim 1 wherein said alkyl amine alkoxylate is tallow amine ethoxylate having 5-25 ethoxylate groups on average.

11. The plant biostimulant adjuvant of claim 10 wherein said tallow amine ethoxylate has 5-15 ethoxylate groups on average.

12. The plant biostimulant adjuvant of claim 1 wherein said alkyl amine alkoxylate is coco amine ethoxylate having 5-20 ethoxylate groups on average.

13. The plant biostimulant adjuvant of claim 12 wherein said coco amine ethoxylate has 8-15 ethoxylate groups on average.

14. The plant biostimulant adjuvant of claim 1 further comprising a drift control additive.

14. The plant biostimulant adjuvant of claim 1 comprising no additional drift control additive.

15. The plant biostimulant adjuvant of claim 1 further comprising a humectant.

16. The plant biostimulant adjuvant of claim 15 wherein said humectant is selected from the group consisting of glycerin, polyethylene glycol, propylene glycol, hexylene glycol, sugar, polypropylene glycol, butyl carbitol, mono ethylene glycol, di ethylene glycol, di ethylene glycol methyl ether, di ethylene glycol butyl ether and combinations thereof.

17. The plant biostimulant adjuvant of claim 1 further comprising a water conditioning agent.

18. The plant biostimulant adjuvant of claim 1 comprising 40-80 wt % biostimulant; 5-25 wt % alkyl amine alkoxylate and 5-20 wt % humectant.

19. The plant biostimulant adjuvant of claim 18 comprising 55-70 wt % biostimulant; 8-20 wt % alkyl amine alkoxylate and 5-25 wt % humectant.

20. The plant biostimulant adjuvant of claim 1 further comprising at least one additive selected from the group consistion of a herbicide, fungicide and a pesticide.

21. The plant biostimulant adjuvant of claim 1 further comprising an agriculturally effective amount of at least one pesticide selected from the group consistion of glufosinate, glyphosate, 2,4-dichlorophenoxy acetic acid and other phenoxy compounds, metribuzin, fomesafen, metolachlor, acetochlor, mesotrione, clethodim, tebuconazole, imazeathepyr, Imidacloprid, Acetamiprid, Clothianidin, Dinotefuran, Nithiazine, Thiacloprid, Thiamethoxam, Metalaxyl, Metalaxyl-M, Ibendazole, Benomyl, Carbendazim, Chlorfenazole, Cypendazole, Debacarb, Fuberidazole, Mecarbinzid, Rabenzazole, Thiabendazole, Thiophanate, Thiophanate-methyl, Epoxiconazole, Triadimenol, Propiconazole, Metconazole, Cyproconazole, Tebuconazole, Azaconazole, Bromuconazole, Diclobutrazol, Difenoconazole, Diniconazolke, Etaconazole, Fenbuconazole, Fluquinconazole, Flutriafol, Furconazole, Hexaconazole, Imibenconazole, Ipconazole, Myclonutanil, Penaconazole, Prothioconazole, Quinconazole, Simeconazole, Tetraconazole, Triadimefon, Triticonazole, Uniconazole, Ampropylfos, Ditalimos, Edifenphos, Fosetyl, Inezin, Iprobenfos, Izoamfos, Phosdipen, Pyrazopos, Toclofos-Ethyl, Triamiphos, Parathion, Acephate, Malathion, Methyl Parathion, Chlorpyrifos, Diazinon, Dichlorvos, Phosmet, Fenitrothion, Tetrachlorvinphos, Azamethiphos, Azinphos Methyl, Fluoxastrobin, Mandestrobin, Azoxystrobin, Coumoxystrobin, Enoxastrobin, Flufenoxystrobin, Picoxystrobin, and Pyaoxystrobin, Pyraclostrobin, Pyrametostobin, Pyrametostrobin, Dimoxystrobin, Fenaminstrobin, Metominoistrobin, Orysastrobin, Trifloxystrobin, Captafol, Captan, Ditalimfos, Folpet, Thiochlorofenphim, Carboxin, Oxycaroboxin, Amobam, Asomate, Azithiram, Carbamorph, Cufraneb, Disulfiram, Ferba m, Metam, Nabam, Tecoram, Thiram, Urbacide, Ziram and combinations thereof.

22. A sprayable tank mix formulation, comprising an agriculturally effective amount of a pesticidally active chemical and the plant biostimulant adjuvant of claim 1.

23. A method of treating a crop comprising:
forming a plant biostimulant adjuvant comprising:
a plant biostimulant comprising at least one of an amino acid or a peptide derived from a plant source;
an alkyl amine alkoxylate defined by the formula: 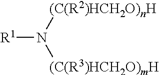
wherein:
R¹ is an alkyl of 6 to 22 carbons;
each R² and R³ are each independently H or CH₃.
n and m are each at least one and taken together n+m is 5 to 25;
mixing said plant biostimulant adjuvant with an agriculturally effective amount of at least one auxiliary adjuvant in a container to form a tank mixture; and
passing said tank mixture through a sprayer to form a spray on said crop.

24. The method of claim 23 wherein R¹ is an alkyl of 12 to 18 carbons.

25. The method of treating a crop of claim 23 wherein said peptide comprises 2-200 amino acids.

26. The method of treating a crop of claim 23 wherein said amino acid is selected from the group consisting of alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine, valine, selenocysteine, pyrrolysine, and oligomers and combinations thereof.

27. The method of treating a crop of claim 26 wherein said amino acid is selected from the group consisting of L-alanine, L-arginine, L-asparagine, L-cysteine, L-glutamic acid, glycine, L-histidine, L-isoleucine, L-leucine, L-lysine, L-methionine, L-phenylalanine, L-proline, L-serine, L-threonine, L-tryptophan, L-tyrosine, L-valine, and combinations thereof.

28. The method of treating a crop of claim 27 wherein said amino acid is selected from the group consisting of L-histidine, L-isoleucine, L-leucine, L-lysine, L-methionine, L-phenylalanine, L-threonine, L-tryptophan, L-valine, and combinations thereof.

29. The method of treating a crop of claim 23 comprising at least 50 to no more than 95 wt % said plant biostimulant and said alkyl amine alkoxylate combined.

30. The method of treating a crop of claim 23 further comprising an alkyl polyglucoside defined by the formula: 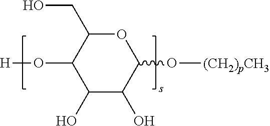
wherein:
s is 1-5; and
p is 7-21.

31. The method of treating a crop of claim 30 wherein p is 15-17.

32. The method of treating a crop of claim 23 wherein said alkyl amine alkoxylate is tallow amine ethoxylate having 5-25 ethoxylate groups on average.

33. The method of treating a crop of claim 32 wherein said tallow amine ethoxylate has 5-15 ethoxylate groups on average.

34. The method of treating a crop of claim 23 wherein said alkyl amine alkoxylate is coco amine ethoxylate having 5-20 ethoxylate groups on average.

35. The method of treating a crop of claim 34 wherein said coco amine ethoxylate has 8-15 ethoxylate groups on average.

36. The method of treating a crop of claim 23 further comprising a drift control additive.

36. The method of treating a crop of claim 23 comprising no additional drift control additive.

37. The method of treating a crop of claim 23 further comprising a humectant.

38. The method of treating a crop of claim 37 wherein said humectant is selected from the group consisting of glycerin, polyethylene glycol, propylene glycol, hexylene glycol, sugar, polypropylene glycol, butyl carbitol, mono ethylene, di ethylene, methyl ether, butyl ether and combinations thereof.

39. The method of treating a crop of claim 23 further comprising a water conditioning agent.

40. The method of treating a crop of claim 23 comprising 40-80 wt % biostimulant; 5-25 wt % alkyl amine alkoxylate and 5-20 wt % humectant.

41. The method of treating a crop of claim 40 comprising 55-70 wt % biostimulant; 8-20 wt % alkyl amine alkoxylate and 5-25 wt % humectant.

42. The method of treating a crop of claim 23 wherein said agriculturally relevant material is selected from the group consisting of herbicides, insecticides and fungicides.

43. The method of treating a crop of claim 23 wherein said auxiliary adjuvant is selected from the group consisting of glufosinate, glyphosate, 2,4-dichlorophenoxy acetic acid and other phenoxy compounds, metribuzin, fomesafen, metolachlor, acetochlor, mesotrione, clethodim, tebuconazole, imazeathepyr, Imidacloprid, Acetamiprid, Clothianidin, Dinotefuran, Nithiazine, Thiacloprid, Thiamethoxam, Metalaxyl, Metalaxyl-M, Ibendazole, Benomyl, Carbendazim, Chlorfenazole, Cypendazole, Debacarb, Fuberidazole, Mecarbinzid, Rabenzazole, Thiabendazole, Thiophanate, Thiophanate-methyl, Epoxiconazole, Triadimenol, Propiconazole, Metconazole, Cyproconazole, Tebuconazole, Azaconazole, Bromuconazole, Diclobutrazol, Difenoconazole, Diniconazolke, Etaconazole, Fenbuconazole, Fluquinconazole, Flutriafol, Furconazole, Hexaconazole, Imibenconazole, Ipconazole, Myclonutanil, Penaconazole, Prothioconazole, Quinconazole, Simeconazole, Tetraconazole, Triadimefon, Triticonazole, Uniconazole, Ampropylfos, Ditalimos, Edifenphos, Fosetyl, Inezin, Iprobenfos, Izoamfos, Phosdipen, Pyrazopos, Toclofos-Ethyl, Triamiphos, Parathion, Acephate, Malathion, Methyl Parathion, Chlorpyrifos, Diazinon, Dichlorvos, Phosmet, Fenitrothion, Tetrachlorvinphos, Azamethiphos, Azinphos Methyl, Fluoxastrobin, Mandestrobin, Azoxystrobin, Coumoxystrobin, Enoxastrobin, Flufenoxystrobin, Picoxystrobin, and Pyaoxystrobin, Pyraclostrobin, Pyrametostobin, Pyrametostrobin, Dimoxystrobin, Fenaminstrobin, Metominoistrobin, Orysastrobin, Trifloxystrobin, Captafol, Captan, Ditalimfos, Folpet, Thiochlorofenphim, Carboxin, Oxycaroboxin, Amobam, Asomate, Azithiram, Carbamorph, Cufraneb, Disulfiram, Ferba m, Metam, Nabam, Tecoram, Thiram, Urbacide, Ziram and combinations thereof.
The method of claim 23 wherein the agriculturally relevant material is an adjuvant selected from the groups of water conditioners, drift reducing agents, volatility reducing agents, surfactants, compatibility agents, antifoams, spray markers, deposition aids and pH buffers and combinations thereof.
The method of claim 23 where in the agriculturally relevant material is a fertilizer.

44. The method of treating a crop of claim 23 wherein said spray has at least 5% fewer droplets below 150 μm in diameter than a compared to an identical spray lacking said plant biostimulant adjuvant sprayed under the same conditions.

45. The method of treating a crop of claim 44 wherein said spray has at least 10%, fewer droplets below 150 μm in diameter than a compared to an identical spray lacking said plant biostimulant adjuvant sprayed under the same conditions.

46. The method of treating a crop of claim 23 to increase the growth rate and resilience of a plant.

47. The method of treating a crop of claim 23 to increase the yield of a plant as compared to a nontreated plant.

48. The method of treating a crop of claim 23 to increase the yield of a plant exposed to an herbicide as compared to a nontreated plant.

49. The method of treating a crop of claim 23 to obtain a more consistent and uniform benefit to the plant as compared to a similar complex lacking surfactants.

50. The method of treating a crop of claim 23 to with a biostimulant adjuvant having improved the physical stability and shelf life.

51. The method of treating a crop of claim 23 to enable the mixing of the biostimulant solution with solvents, pesticides, oils, fertilizers, and surfactants that would typically be incompatible.

52. The method of treating a crop of claim 23 to enable the application of the biostimulant solution with solvents, pesticides, oils, fertilizers, and surfactants in a single formula that would typically need to be applied as separate components due to physical incompatibility under most conditions.
